(19) United States
(12) Patent Application Publication
(10) Pub. No.: US 2022/0235953 A1
(43) Pub. Date: Jul. 28, 2022

(54) COOLING FAN

(71) Applicant: Weiquan Zou, Xinhua (CN)

(72) Inventor: Weiquan Zou, Xinhua (CN)

(21) Appl. No.: 17/719,417

(22) Filed: Apr. 13, 2022

(30) Foreign Application Priority Data
Mar. 14, 2022 (CN) 202210249457.0

(51) Int. Cl. F24F 6/16; F24F 13/28; F24F 13/08

(52) U.S. Cl. CPC F24F 6/16; F24F 2006/008; F24F 13/082; F24F 13/28

(57) ABSTRACT

The present disclosure discloses a cooling fan, including a housing and a water tank. An air blowing system, and an air inlet and an air outlet corresponding to the air blowing system are arranged in the housing; the water tank is arranged in the housing; an atomizer is configured in the water tank; the air blowing system is communicated with the water tank; a plurality of mist vents are formed in the housing; the plurality of mist vents are all communicated with the water tank; and the plurality of mist vents are located at the air inlet and/or the air outlet.

### TECHNICAL FIELD

The present disclosure relates to the technical field of household appliances, in particular to a cooling fan.

### BACKGROUND

A cooling fan is also referred to as an air conditioner fan, a water-cooled air conditioner, a cold air blower, etc. It is a common household appliance at present and integrates multiple functions of air supplying, refrigeration, humidification, and the like.

A spray cooling fan is one of the most common cooling fans at present. Especially, the spray cooling fan generally adopts one atomizer for single-point spraying, or adopts multiple atomizers that work independently for multi-point spraying. In the single-point spraying method, non-uniform spraying is easily caused, resulting in an unbalanced cooling of an air flow at an air outlet. The use of multiple atomizers will increase the manufacturing and use cost.

### SUMMARY

In view of this, the present disclosure discloses a cooling fan, which can achieve multi-point spraying with a single atomizer, so that balanced cooling of an air flow at the air outlet is guaranteed while the manufacturing and use cost is reduced.

The present disclosure discloses a cooling fan, including:

a housing, wherein an air blowing system, and an air inlet and an air outlet corresponding to the air blowing system are arranged in the housing; and

a water tank arranged in the housing, wherein an atomizer is configured in the water tank, and the air blowing system is communicated with the water tank;

a plurality of mist vents are formed in the housing; the plurality of mist vents are all communicated with the water tank; and the plurality of mist vents are located at the air inlet and/or the air outlet.

Further, the air blowing, system includes a main fan and an atomization fan; the main fan corresponds to the air inlet and the air outlet; and the atomization fan corresponds to the water tank to blow air to the water tank.

Further, the air blowing system includes a main fan; the main fan corresponds to the air inlet and the air outlet; and the water tank is communicated with an air blowing end of the main fan through an air duct.

Further, the mist vents are located at the air outlet.

Further, a filter member is provided at the air inlet; and the filter member is arranged on the outer side of the air inlet through a grid plate.

Further, one or more discharged mist separation strips are arranged at the air outlet; and the mist vents are formed in the discharged mist separation strips.

Further, the plurality of discharged mist separation strips are vertically disposed, and are uniformly distributed at the air outlet along a horizontal direction.

Further, the discharged mist separation strips are annularly disposed, and the plurality of discharged mist separation strips are in divergent distribution towards the outside.

Further, an air guide member is arranged between the discharged mist separation strips and the air blowing system, and the air duct is arranged on the air guide member.

Compared with the existing art, the technical solution of the present disclosure has the beneficial effects.

The atomizer acts on water in the water tank to generate water mist; the generated water mist is discharged through the plurality of mist vents under the action of the air blowing system and is then blown out from the air outlet under the action of the air blowing system. so that multi-point mist spraying is achieved with a single atomizer; and balanced cooling of an air flow at the air outlet is guaranteed while the manufacturing and use cost is reduced.

### BRIEF DESCRIPTION OF THE DRAWINGS

FIG. 1 is a schematic diagram of an appearance structure of a cooling fan;

FIG. 2 is an exploded diagram of a cooling fan;

FIG. 3 is a schematic structural diagram of a front shell at one visual angle;

FIG. 4 is a schematic structural diagram of the front shell at another visual angle;

FIG. 5 is a sectional view of a cooling fan;

FIG. 6 is a schematic diagram illustrating that a main fan is communicated with the water tank through an air duct;

FIG. 7 is a schematic structural diagram of a connector.

Reference signs in drawings:

100: cooling fan, 10: housing; 11: front shell; 12: rear shell; 13: bottom shell; 14: connector; first connection through hole; 142: second connection through hole; 15: air inlet; 16: air outlet; 17: filter member; 18: grid plate; 20: air blowing system; 21: main fan; 22: air guide member, 30: water tank; 31: atomizer; 40: mist vent; 41: discharged mist separation strip; and 42: air duct.

### DETAILED DESCRIPTION OF THE EMBODIMENTS

The technical solutions in the embodiments of the present disclosure will be dearly and completely described below with reference to the accompanying drawings in the embodiments of the present disclosure. It should be noted that when a component is considered to be “connected” to another component, it may be directly connected to another component, or an intermediate component possibly exists at the same time. Unless otherwise defined, all technical and scientific terms used herein are the same as meanings of general understandings of those skilled in the art of the disclosure. It should be further noted that unless otherwise explicitly specified and defined, the terms “mounted”, “coupled” and “connected” shall be understood broadly, and may he, for example, fixedly connected, or detachably connected, or integrally connected, or mechanically connected, or electrically connected, or interconnection between the interiors of two elements. Those of ordinary skill in the art can understand the specific meanings of the above terms in the present disclosure according to specific situations. The terms used in the description of the disclosure herein are merely to describe the specific embodiments, not intended to limit the disclosure.

It should be further noted that in the description of the present disclosure, it should be noted that orientations or positional relationships indicated by the terms “center”, “upper”, “lower”, “left”, “right”, “vertical”, “horizontal”, “inside”, “outside”, and the like are orientations or positional relationships as shown in the drawings, and are only for the purpose of facilitating and simplifying the description of the present disclosure instead of indicating or implying that devices or elements indicated must have particular orientations, and be constructed and operated in the particular orientations, so that these terms are not construed as limiting the present disclosure. In addition, the terms “first”, “second” and “third” are only for the purpose of description, and may not be understood as indicating or implying the relative importance.

The present disclosure discloses a cooling fan, which achieves balanced cooling of an air flow while the manufacturing and use cost is reduced.

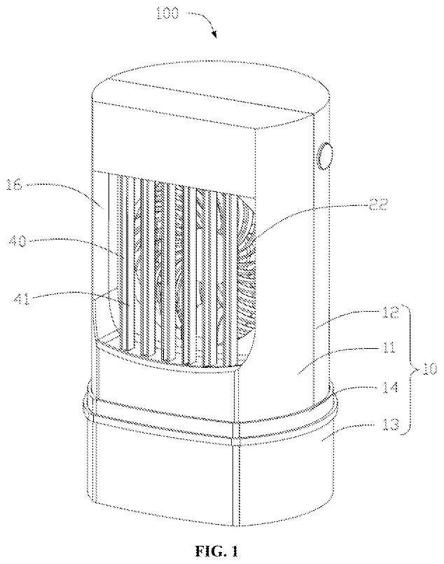

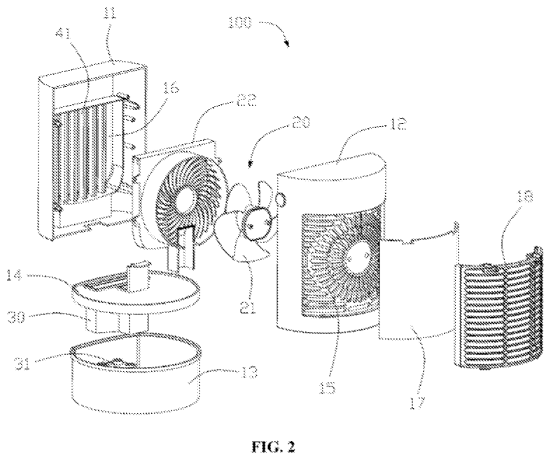

As shown in FIG. 1 and FIG. 2, the cooling fan 100 includes a housing 10, an air blowing system 20, and a water tank 30. The air blowing system 20 and the water tank 30 are located in the housing 10. The housing 10 is provided with an air inlet 15 and an air outlet 16 corresponding to the air blowing system 20. When working, the air blowing system 20 draws air from the air inlet 15 and blows air from the air outlet 16 to an external space, A corresponding atomizer 31 is arranged in the water tank 30. The atomizer 31. atomizes water in the water tank 30, and the mist is blown from the air outlet 16 under the action of the air blowing system 20.

The housing 10 includes a front shell 11, a rear shell 12, and a bottom shell 13; the front shell 11 and the rear shell 12 fixedly cooperate with each other to form a shell body with an accommodating space; the air blowing system 20 is arranged in the shell body formed by connecting the front shell 11 with the rear shell 12; the air outlet 16 is located on the front shell 11. and the air inlet 15 is located on the rear shell 12. The bottom shell 13 is located at the bottom of the housing 10.

The bottom shell 13 cooperates with the front shell 11 and the rear shell 12 through the connector 14. The water tank 30 is located in the bottom shell 13.

In the present disclosure, the water tank 30 may be fixed in the bottom shell 13, or may cooperate with the bottom shell 13 by using a detachable structure, so that the water tank 30 may be removed from the housing 10 according to a need. In the present disclosure, the arrangement manner for the water tank 30 is not specifically limited.

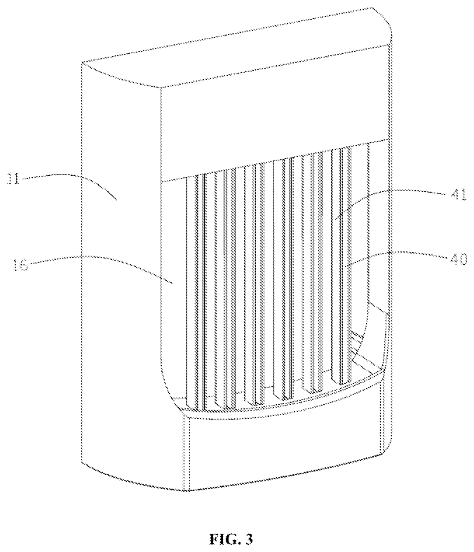

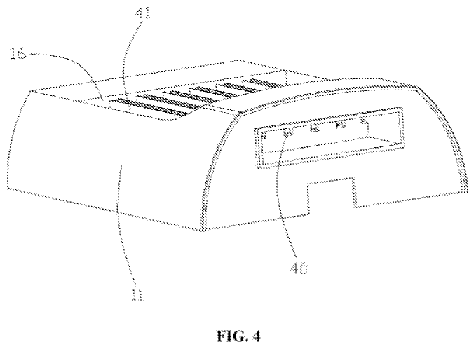

As shown in FIG. 3 and FIG. 4, in the present disclosure, the housing 10 is provided with a plurality of mist vents 40. The plurality of mist vents 40 are respectively disposed at the air inlet 15 and/or the air outlet 16. The water tank 30 is simultaneously connected to the air blowing system 20 and the plurality of mist vents 40, respectively. Water mist generated by the atomizer 31 that acts on the water in the water tank 30 is simultaneously blown out from the plurality of mist vents 40 under the action of the air blowing system 20 and is then discharged from the air outlet 16 under the action of the air blowing system 20. The plurality of mist vents 40 are arranged to achieve multi-point spraying of the cooling fan 100. which ensures that an air flow blown out of the air blowing system 20 achieves uniform cooling at the air outlet 16. Furthermore, the single atomizer 31 is arranged to cooperate with the plurality of mist vents 40 to achieve multi-point spraying, which can reduce the manufacturing cost and the energy consumption during use and reduce the use cost.

Further, the plurality of mist vents 40 may be simultaneously arranged at the air outlet 16 or simultaneously arranged at the air inlet 15, or the air outlet 16 and the air inlet 15 are both provided with the corresponding mist vents 40. This can be specifically set according to usage and design requirements. Preferably, the plurality of mist vents 40 are arranged at the air outlet 16.

The air outlet 16 is provided with one or more discharged mist separation strips 41. The discharged mist separation strips 41 and the front shell 11 are integrated. The discharged mist separation strips 41 are located at an air discharging end of the air blowing system 20. The discharged mist separation strips 41 are hollowed. The mist vents 40 are located in the discharged mist separation strips 41 and are communicated with the water tank 30, After the water in the water tank 30 is atomized by the atomizer 31 to generate the water mist, under the action of the air blowing system 20, the water mist is blown out from the mist vents 40 along the discharged mist separation strips 41. In the present disclosure, when there is one discharged mist separation strip 41, each discharged mist separation strip 41 may be provided with a plurality of mist vents 40, or the mist vents 40 that are shaped like the discharged mist separation strip 41 are provided.

In one implementation, the plurality of discharged mist separation strips 41 are vertically disposed, and are uniformly distributed at the air outlet 16 along a horizontal direction. in this embodiment, the plurality of vertically disposed discharged mist separation strips 41 are horizontally uniformly distributed, A space for air to pass through is arranged between two adjacent discharged mist separation strips 41, so that when the mist is discharged uniformly at the air outlet 16, the air blown by the air blowing system 20 can also be guided.

In another embodiment, the discharged mist separation strips 41 are all annularly disposed. When there is one discharged mist separation strip 41, the one discharged mist separation strip 41 may be uniformly distributed with a plurality of mist vents 40, or mist vents 40 corresponding to the shape of the discharged mist separation strip 41. When there are a plurality of discharged mist separation strips 41, the plurality of discharged mist separation strips 41 may be independently disposed, or may be in a divergent distribution from inside to outside.

The discharged mist separation strips 41 may be of a strip shape, a ring shape, or other shapes, The shape is not specifically limited here.

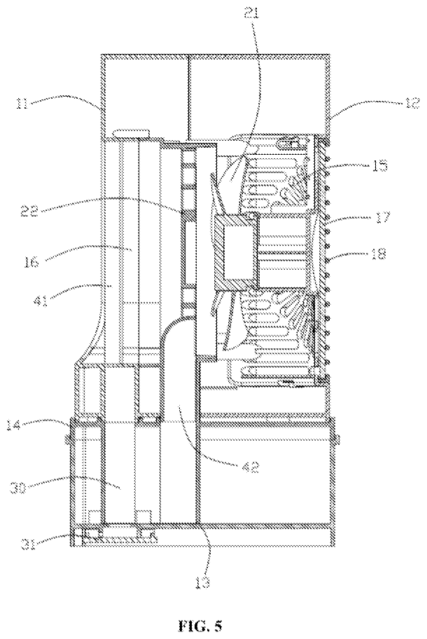

Continuing to refer to FIG. 5, further, an air guide member 22 is arranged between the discharged mist separation strips 41 and the air blowing system 20. Specifically, the air guide member 22 is fixedly connected to the front shell 11, and the air guide member 22 is provided with a hole for air to pass through.

Further, a filter member 17 is provided at the air inlet 15; and the filter member 17 is arranged on the outer side of the air inlet 15 through a grid plate 18. Specifically, the air inlet 15 is arranged on the rear shell 12; and the filter member 17 is arranged on the outer side of the air inlet 15. When working, the air blowing system 20 extracts air from the outside through the air inlet 15. The filter member 17 is used for filtering the extracted air to prevent debris from enter the housing 10 through the air inlet 15. The grid plate 18 is clamped with the rear shell 12. The filter member 17 is arranged in an accommodating space formed by clamping between the grid plate 18 and the rear shell 12. The grid plate 18 is provided with a plurality of holes for air to pass through. The filter member 17 is made of one or more materials of sponge, filter paper, cotton cloth, nonwoven cloth, and the like.

When working, the air blowing system 20 extracts air from the air inlet 15 and blows air from the air outlet 16. Furthermore, the water mist discharged by the mist vents 40 is blown out from the air outlet 16 to cool and humidify the external space.

In one embodiment, the air blowing system 20 includes a main fan 21 and an atomization fan; the main fan 21 corresponds to the air inlet 15 and the air outlet 16; and the atomization fan blows air to the water tank 30. Specifically, the main fan 21 can be fixedly connected to the front shell 11 or the rear shell 12. When working, the main fan 21 extracts air from the air inlet 15 and then blows air from the air outlet 16 to the outside. At the same time, when multi-point spraying is needed, the atomization fan works to blow air into the water tank 30, so as to blow the water mist generated by atomization out of the mist vents 40. The water mist is then blown to the external space under the action of the main fan 21.

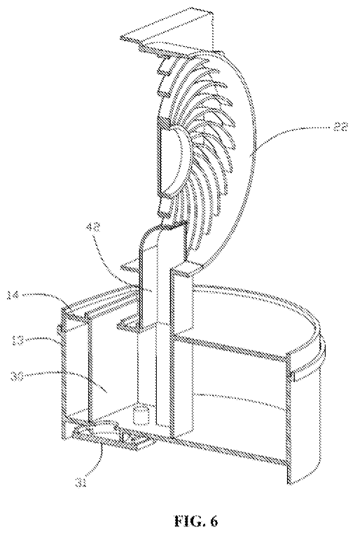

As shown in FIG. 5 and FIG. 6, in another embodiment, the air blowing system 20 includes a main fan 21. The main fan 21 corresponds to the air inlet 15 and the air outlet 16, The water tank 30 is communicated to an air blowing end of the main fan 21 through an air duct 42. When working, the main fan 21 may extract air from the air inlet 15, and blow air to the air outlet 16 and the air duct 42. An air flow generated during the working of the main fan 21 partially passes through the air duct 42 and enters the water tank 30. The water mist, generated by atomization by the atomizer 31, in the water tank 30 is blown out of the mist vents 40 under the action of the corresponding air flow and is blown to the external space under the action of the air flow of the air outlet 16. Only one main fan 21 can meet the air blowing requirement and the spraying requirement of the cooling fan 100.

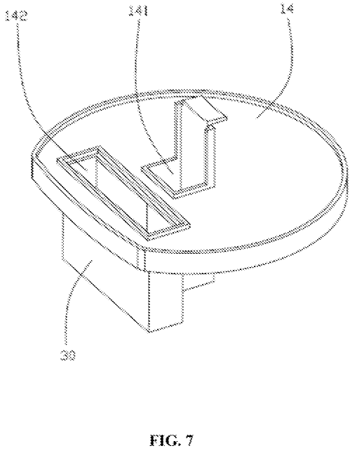

As shown in FIG. 6 and FIG. 7, in the present disclosure, the air duct 42 is arranged on the air guide member 22. The air guide member 22 is injection-molded. The connector 14 is provided with a first connection through hole 141. The air duct 42 is communicated with the water tank 30 in the bottom shell 13 through the first connection through hole 141. The connector 14 is further provided with a second connection through hole 142. The plurality of mist vents 40 are communicated with the water tank 30 in the bottom shell 13 through the second connection through hole 142. Joints between the mist vents 40 and the second connection through hole 142 are in sealing fit.

Working principle:

The atomizer 31 atomizes the water in the water tank 30 to generate the water mist. The air blowing system 20 can work to blow out the water mist in the water tank 30 from the plurality of mist vents 40 to achieve multi-point spraying at the air outlet 16 or the air inlet 15. At the same time, the water mist sprayed from the mist vents 40 is blown to the external space from the air outlet 16 under the action of the air blowing system 20. The multi-point spraying ensures the balanced cooling of the air flow at the air outlet 16, and the single atomizer 31 can meet the requirement of multi-point spraying, thus reducing the manufacturing cost and the use cost.

The present disclosure can have various implementations and transformations without departing from the generalized spirit and scope of the present disclosure. The above implementations are used for illustrating the invention, but not intended to limit the scope of the present disclosure.

What is claimed is:

1. A cooling fan, comprising:
a housing, wherein an air blowing system, and an air inlet and an air outlet corresponding to the air blowing system are arranged in the housing; and
a water tank arranged in the housing, wherein an atomizer is configured in the water tank, and the air blowing system is communicated with the water tank;
a plurality of mist vents are formed in the housing; the plurality of mist vents are all communicated with the water tank; and the plurality of mist vents are located at the air inlet and/or the air outlet.

2. The cooling fan according to claim 1, wherein the air blowing system comprises a main fan and an atomization fan; the main fan corresponds to the air inlet and the air outlet; and the atomization fan corresponds to the water tank to blow air to the water tank.

3. The cooling fan according to claim 1, wherein the air blowing system comprises a main fan;
the main fan corresponds to the air inlet and the air outlet; and the water tank is communicated with an air blowing end of the main fan through an air duct.

4. The cooling fan according to claim 3, wherein the mist vents are located at the air outlet.

5. The cooling fart according to claim 4, wherein a filter member is provided at the air inlet; and the filter member is arranged on the outer side of the air inlet through a grid plate.

6. The cooling fan according to claim 4. wherein one or more discharged mist separation strips are arranged at the air outlet; and the mist vents are formed in the discharged mist separation strips.

7. The cooling fan according to claim 6, wherein the plurality of discharged mist separation strips are vertically disposed, and are uniformly distributed at the air outlet along a horizontal direction.

8. The cooling fan according to claim 6. wherein the discharged mist separation strips are annularly disposed.

9. The cooling fan according to claim 6, wherein an air guide member is arranged between the discharged mist separation strips and the air blowing system, and the air duct is arranged on the air guide member.
